(19) United States
(12) Patent Application Publication
(10) Pub. No.: US 2025/0097295 A1
(43) Pub. Date: Mar. 20, 2025

(54) ON-BOARD APPARATUS, ABNORMALITY DETECTION METHOD, AND ABNORMALITY DETECTION PROGRAM

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventor: Tomoya KONO, Yokkaichi-shi, Mie (JP)

(73) Assignees: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(21) Appl. No.: 18/290,766

(22) PCT Filed: Jun. 27, 2022
(86) PCT No.: PCT/JP2022/025507

§ 371 Date: Jan. 20, 2024

(30) Foreign Application Priority Data
Jul. 26, 2021 (JP) 2021-121511

(51) Int. Cl. H04L 67/12; H04L 43/0882

(52) U.S. Cl. CPC H04L 67/12; H04L 43/0882

(57) ABSTRACT

An on-board apparatus includes: a receiving unit configured to receive, via a transmission path, a plurality of pieces of change information respectively indicating changes in measurement results of a plurality of sensors mounted in a vehicle, a delay processing unit configured to perform delay processing for delaying and outputting at least one of the plurality of pieces of change information received by the receiving unit, and a detection unit configured to detect an abnormality based on an internal output sequence that is an output sequence in which the delay processing unit outputs the plurality of pieces of change information.

### CROSS-REFERENCE TO RELATED APPLICATIONS

This application is the U.S. national stage of PCT/JP2022/025507 filed on Jun. 27, 2022, which claims priority of Japanese Patent Application No. JP 2021-121511 filed on Jul. 26, 2021, the contents of which are incorporated herein.

### TECHNICAL FIELD

The present disclosure relates to an on-board apparatus, an abnormality detection method, and an abnormality detection program.

### BACKGROUND

JP 2012-190408A discloses an abnormality diagnosis apparatus to be described below. That is to say, the abnormality diagnosis apparatus is an abnormality diagnosis apparatus that performs abnormality diagnosis in a system having a hierarchical structure formed by a plurality of sub systems, and includes: a normal operation model accumulation unit configured to store a normal operation model for each of the system and the sub systems, an actual operation extraction unit configured to extract actual operation data for each of the system and the sub systems, a normal operation model comparison unit configured to, for each of the system and the sub systems, perform local determination, in which determination is made as “normal” if the normal operation model includes the actual operation data, and determination is made that “there is the possibility of an abnormality” if the normal operation model does not include the actual operation data, and a comprehensive determination unit configured to perform comprehensive determination that “there is a high likelihood of an abnormality” and determine the sub system on the lowermost layer of the hierarchical structure as an abnormality site if the local determination regarding the system indicates that “there is the possibility of an abnormality” and all of the local determinations included in a retroactive route for tracking back from the sub system on the lowermost layer of the hierarchical structure and reaching the sub system on the uppermost layer of the hierarchical structure indicate that “there is the possibility of an abnormality”.

Heretofore, techniques for detecting an abnormality in an on-board system have been proposed.

Besides the technique described in JP 2012-190408A, techniques for detecting, as an abnormality, that a door of a vehicle has been forcefully opened by a person other than an authorized user, or the like, based on a measurement result of a sensor, and issuing an alert have been proposed for the purpose of anti-theft of the vehicle and the like.

However, there are cases where, in conventional abnormality detection techniques, false detection occurs in abnormality detection that is based on a measurement result of a sensor, depending on a situation of an on-board network.

The present disclosure has been made in order to solve the above-described issue, and an aim of the present disclosure is to provide an on-board apparatus, an abnormality detection method, and an abnormality detection program that make it possible to suppress the occurrence of false detection in abnormality detection that is based on a measurement result of a sensor.

### SUMMARY

An on-board apparatus according to the present disclosure is an on-board apparatus to be mounted in a vehicle, and includes: a receiving unit configured to receive, via a transmission path, a plurality of pieces of change information respectively indicating changes in measurement results of a plurality of sensors mounted in the vehicle, a delay processing unit configured to perform delay processing for delaying and outputting at least one of the plurality of pieces of change information received by the receiving unit, and a detection unit configured to detect an abnormality based on an internal output sequence that is an output sequence in which the delay processing unit outputs the plurality of pieces of change information.

An abnormality detection method according to the present disclosure is an abnormality detection method for an on-board apparatus to be mounted in a vehicle, and includes: a step of receiving, via a transmission path, a plurality of pieces of change information respectively indicating changes in measurement results of a plurality of sensors mounted in the vehicle, a step of performing delay processing for delaying and outputting at least one of the plurality of pieces of received change information, and a step of detecting an abnormality based on an internal output sequence that is an output sequence of the plurality of pieces of change information.

An abnormality detection program according to the present disclosure is an abnormality detection program in an on-board apparatus to be mounted in a vehicle, and causes a computer to function as: a receiving unit configured to receive, via a transmission path, a plurality of pieces of change information respectively indicating changes in measurement results of a plurality of sensors mounted in the vehicle, a delay processing unit configured to perform delay processing for delaying and outputting at least one of the plurality of pieces of change information received by the receiving unit, and a detection unit configured to detect an abnormality based on an internal output sequence that is an output sequence in which the delay processing unit outputs the plurality of pieces of change information.

An aspect of the present disclosure can be realized not only as an on-board apparatus that includes such characteristic processing units, but can also be realized as a semiconductor integrated circuit that realizes a portion or the entirety of the on-board apparatus, or an on-board communication system that includes the on-board apparatus.

### Advantageous Effects

According to the present disclosure, it is possible to suppress the occurrence of false detection in abnormality detection that is based on a measurement result of a sensor.

### BRIEF DESCRIPTION OF DRAWINGS

FIG. 1 is a diagram showing a configuration of an on-board communication system according to an embodiment of the present disclosure.

FIG. 2 is a diagram showing an example of sensor data transmitted by a sensor in the on-board communication system according to the embodiment of the present disclosure.

FIG. 3 is a diagram showing an example of sensor data transmitted by a sensor in the on-board communication system according to the embodiment of the present disclosure.

FIG. 4 is a diagram showing an example of sensor data transmitted by a sensor in the on-board communication system according to the embodiment of the present disclosure.

FIG. 5 is a diagram showing a configuration of an integrated ECU according to the embodiment of the present disclosure.

FIG. 6 is a diagram showing an example of a delay time table stored in a storage unit of the integrated ECU according to the embodiment of the present disclosure.

FIG. 7 is a diagram showing an example of a correspondence table stored in the storage unit of the integrated ECU according to the embodiment of the present disclosure.

FIG. 8 is a diagram showing an example of delay processing that is performed by a delay processing unit of the integrated ECU according to the embodiment of the present disclosure.

FIG. 9 is a diagram showing an example of an abnormality type table stored in the storage unit of the integrated ECU according to the embodiment of the present disclosure.

FIG. 10 is a flowchart for defining an exemplary operation procedure when the integrated ECU according to the embodiment of the present disclosure detects an abnormality.

### DETAILED DESCRIPTION OF PREFERRED EMBODIMENTS

First, content of embodiments of the present disclosure will be listed and described.

An on-board apparatus according to an embodiment of the present disclosure is an on-board apparatus to be mounted in a vehicle, and includes: a receiving unit configured to receive, via a transmission path, a plurality of pieces of change information respectively indicating changes in measurement results of a plurality of sensors mounted in the vehicle, a delay processing unit configured to perform delay processing for delaying and outputting at least one of the plurality of pieces of change information received by the receiving unit, and a detection unit configured to detect an abnormality based on an internal output sequence that is an output sequence in which the delay processing unit outputs the plurality of pieces of change information.

Due to a configuration in which, as described above, delay processing for delaying and outputting at least one of the plurality of pieces of received change information is performed and abnormality detection is performed based on the internal output sequence of the plurality of pieces of change information, it is possible to determine whether or not an abnormality has occurred, based on an internal output sequence in which the influence from a transmission delay of change information is reduced, and whose content is closer to an external transmission sequence in which the sensors transmit the change information, for example, and thus, it is possible to suppress false detection caused by the influence from a transmission delay of change information. Therefore, it is possible to suppress the occurrence of false detection in abnormality detection that is based on measurement results of the sensors.

The delay processing unit may adjust a delay time in the delay processing based on a load amount of the transmission path.

With such a configuration, a delay time in the delay processing can be set to a value that is based on a transmission delay of change information, and thus, compared with a configuration in which a delay time is set to a predetermined value, it is possible to more accurately determine whether or not an abnormality has occurred, based on the internal output sequence whose content is closer to the external transmission sequence in which the sensors transmit the change information.

The delay processing unit may delay the change information such that the internal output sequence differs from a receiving sequence in which the receiving unit receives the plurality of pieces of change information.

With such a configuration, it is possible to more accurately determine whether or not an abnormality has occurred, based on an internal output sequence for which inversion of a receiving sequence caused by the influence from a transmission delay of change information is resolved, for example.

The delay processing unit may delay the change information received by the receiving unit via another transmission path, by a time that is based on a load amount of the transmission path.

With such a configuration, it is possible to determine whether or not an abnormality has occurred, based on an internal output sequence in which a transmission delay of change information is offset by delaying other change information by a time that is based on the transmission delay.

The delay processing unit may adjust a delay time in the delay processing based on measurement results of load amounts of a plurality of transmission paths.

With such a configuration, in the delay processing, it is possible to set a delay in comprehensive consideration of transmission delays of a plurality of pieces of change information, and delay change information.

The on-board apparatus may further include: a storage unit configured to store correspondence information indicating a correspondence relation between a transmission path for which a load amount satisfies a predetermined condition and change information to be delayed, and the delay processing unit may perform the delay processing based on the correspondence information.

With such a configuration, it is possible to easily set a delay time in the delay processing based on a predetermined correspondence relation between a transmission path and change information to be delayed.

The on-board apparatus may further include a storage unit configured to store abnormality type information indicating a correspondence relation between a type of abnormality to be detected by the detection unit, and an external transmission sequence in which the plurality of sensors transmit the plurality of pieces of change information, and the detection unit may detect a plurality of types of abnormalities based on the abnormality type information and the internal output sequence.

With such a configuration, it is possible to detect various types of abnormalities based on the internal output sequence.

An abnormality detection method according to an embodiment of the present disclosure is an abnormality detection method for an on-board apparatus to be mounted in a vehicle, and includes: a step of receiving, via a transmission path, a plurality of pieces of change information respectively indicating changes in measurement results of a plurality of sensors mounted in the vehicle, a step of performing delay processing for delaying and outputting at least one of the plurality of pieces of received change information, and a step of detecting an abnormality based on an internal output sequence that is an output sequence of the plurality of pieces of change information.

With the method for performing delay processing for delaying and outputting at least one of the plurality of pieces of received change information, and performing abnormality detection based on the internal output sequence of a plurality of pieces of change information, as described above, it is possible to determine whether or not an abnormality has occurred based on an internal output sequence, for which the influence from a transmission delay of change information is reduced, and whose content is closer to an external transmission sequence in which the sensors transmit the change information, for example, and thus, it is possible to suppress false detection caused by the influence from a transmission delay of change information. Therefore, it is possible to suppress the occurrence of false detection in abnormality detection that is based on measurement results of the sensors.

An abnormality detection program according to an embodiment of the present disclosure is an abnormality detection program in an on-board apparatus to be mounted in a vehicle, and causes a computer to function as: a receiving unit configured to receive, via a transmission path, a plurality of pieces of change information respectively indicating changes in measurement results of a plurality of sensors mounted in the vehicle, a delay processing unit configured to perform delay processing for delaying and outputting at least one of the plurality of pieces of change information received by the receiving unit, and a detection unit configured to detect an abnormality based on an internal output sequence that is an output sequence in which the delay processing unit outputs the plurality of pieces of change information.

Due to a configuration in which, as described above, delay processing for delaying and outputting at least one of the plurality of pieces of received change information is performed and abnormality detection is performed based on the internal output sequence of the plurality of pieces of change information, it is possible to determine whether or not an abnormality has occurred, based on an internal output sequence in which the influence from a transmission delay of change information is reduced, and whose content is closer to an external transmission sequence in which the sensors transmit the change information, for example, and thus, it is possible to suppress false detection caused by the influence from a transmission delay of change information. Therefore, it is possible to suppress the occurrence of false detection in abnormality detection that is based on measurement results of the sensors.

Embodiments of the present disclosure will be described below with reference to the drawings. Note that the same reference numerals are given to the same or equivalent portions in the drawings, and repeated descriptions thereof will be omitted. In addition, at least some of the embodiments described below may be combined as appropriate.

### Configuration and Basic Operations

### On-Board Communication System

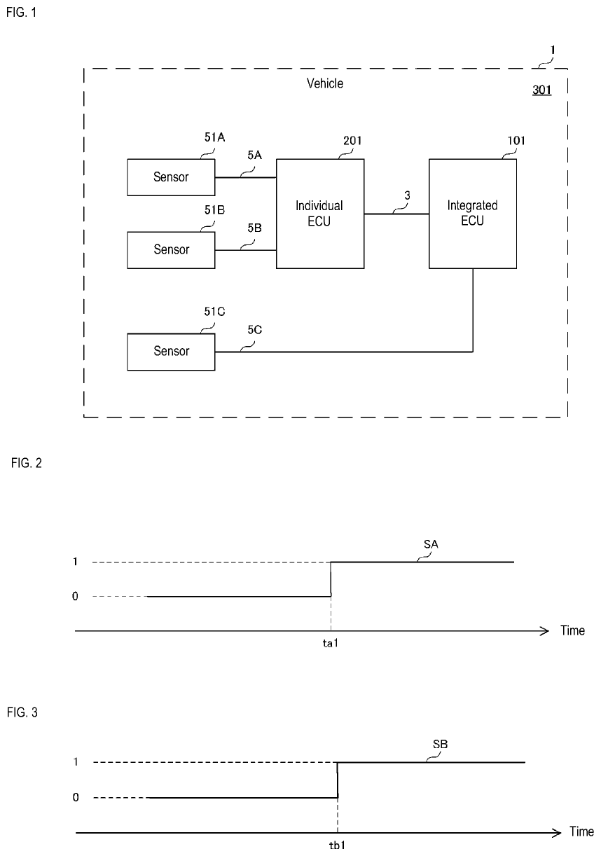

FIG. 1 is a diagram showing a configuration of an on-board communication system according to an embodiment of the present disclosure. As shown in FIG. 1, an on-board communication system 301 includes an integrated ECU (electronic control unit) 101, an individual ECU 201, and sensors 51A, 51B, and 51C. The on-board communication system 301 is to be mounted in a vehicle 1. Hereinafter, each of the sensors 51A, 51B, and 51C is also referred to as a “sensor 51”. The integrated ECU 101, the individual ECU 201, and the sensors 51 are examples of an on-board apparatus.

The sensor 51A is connected to the individual ECU 201 via a cable 5A. The sensor 51B is connected to the individual ECU 201 via a cable 5B. The sensor 51C is connected to the integrated ECU 101 via a cable 5C. The individual ECU 201 is connected to the integrated ECU 101 via a cable 3. Hereinafter, each of the cables 5A, 5B, and 5C is also referred to as a “cable 5”.

Note that the on-board communication system 301 may be configured to include two or four or more sensors 51. In addition, the on-board communication system 301 may also be configured to include two or more integrated ECUs 101. In addition, the on-board communication system 301 may also be configured to include two or more individual ECUs 201. If the on-board communication system 301 includes two or more individual ECUs 201, the network topology of the integrated ECU 101 and the plurality of individual ECUs 201 may be a bus network topology, or a star network topology centered on the integrated ECU 101.

The cables 3 and 5 are transmission lines that comply with the CAN (Controller Area Network, registered trademark), FlexRay (registered trademark), MOST (Media Oriented Systems Transport, registered trademark), Ethernet (registered trademark), or LIN (Local Interconnect Network) standard, for example. Note that the cables 3 and 5 may be signal lines through which analog signals can be transmitted, for example.

The sensors 51A and 51B each store sensor data indicating a measurement result, in a frame that complies with the CAN, Ethernet, or LIN standard, and transmits the frame to the individual ECU 201. The sensor 51C stores sensor data indicating a measurement result in a frame that complies with the CAN, Ethernet, or LIN standard, and transmits the frame to the integrated ECU 101.

### Sensor Data SA

The sensor 51A is a fingerprint sensor for detecting that a person has touched the vehicle body of the vehicle 1, for example. The sensor 51A periodically performs a measurement during a period during which the vehicle 1 is parked, for example, generates sensor data SA indicating whether or not a person is touching the vehicle body of the vehicle 1, stores the generated sensor data SA in a frame, and transmits the frame to the individual ECU 201.

FIG. 2 is a diagram showing an example of sensor data that is transmitted by a sensor in the on-board communication system according to the embodiment of the present disclosure. FIG. 2 shows a timing chart of the sensor data SA that is transmitted by the sensor 51A. In FIG. 2, the horizontal axis indicates time.

As shown in FIG. 2, when no one is touching the vehicle body of the vehicle 1, the sensor 51A stores the sensor data SA whose value is “0”, in a frame, and transmits the frame to the individual ECU 201, and, when a person is touching the vehicle body of the vehicle 1, the sensor 51A stores the sensor data SA whose value is “1” in a frame, and transmits the frame to the individual ECU 201.

If a person touches the vehicle body of the vehicle 1 at time ta1, for example, the value of the sensor data SA changes from “0” to “1”. The sensor data SA at a timing when the value changes from “0” to “1”, out of the sensor data SA that is periodically transmitted by the sensor 51A, is also referred to as “sensor data SAV”.

### Sensor Data SB

The sensor 51B is a vibration sensor for detecting vibration of the vehicle 1, for example. The sensor 51B periodically performs a measurement during a period during which the vehicle 1 is parked, for example, generates the sensor data SB indicating the magnitude of the vibration of the vehicle 1, stores the generated sensor data SB in a frame, and transmits the frame to the individual ECU 201.

FIG. 3 is a diagram showing an example of sensor data that is transmitted by a sensor in the on-board communication system according to the embodiment of the present disclosure. FIG. 3 shows a timing chart of the sensor data SB that is transmitted by the sensor 51B. In FIG. 3, the horizontal axis indicates time.

As shown in FIG. 3, if the magnitude of vibration of the vehicle 1 is smaller than a predetermined value, the sensor 51B stores the sensor data SB whose value is “0”, in a frame, and transmits the frame to the individual ECU 201, and, if the magnitude of vibration of the vehicle 1 is larger than or equal to the predetermined value, the sensor 51B stores the sensor data SB whose value is “1”, in a frame, and transmits the frame to the individual ECU 201.

When the magnitude of vibration of the vehicle 1 reaches the predetermined value or higher at time tb1, for example, the value of the sensor data SB changes from “0” to “1”. The sensor data SB at a timing when the value changes from “0” to “1”, out of the sensor data SB that is periodically transmitted by the sensor 51B, is also referred to as “sensor data SBV”.

### Sensor Data SC

The sensor 51C is a door knob sensor for detecting that a door of the vehicle 1 is opened, for example. The sensor 51C periodically performs a measurement during a period during which the vehicle 1 is parked, for example, generates sensor data SC indicating whether or not a door of the vehicle 1 is open, stores the generated sensor data SC in a frame, and transmits the frame to the individual ECU 201.

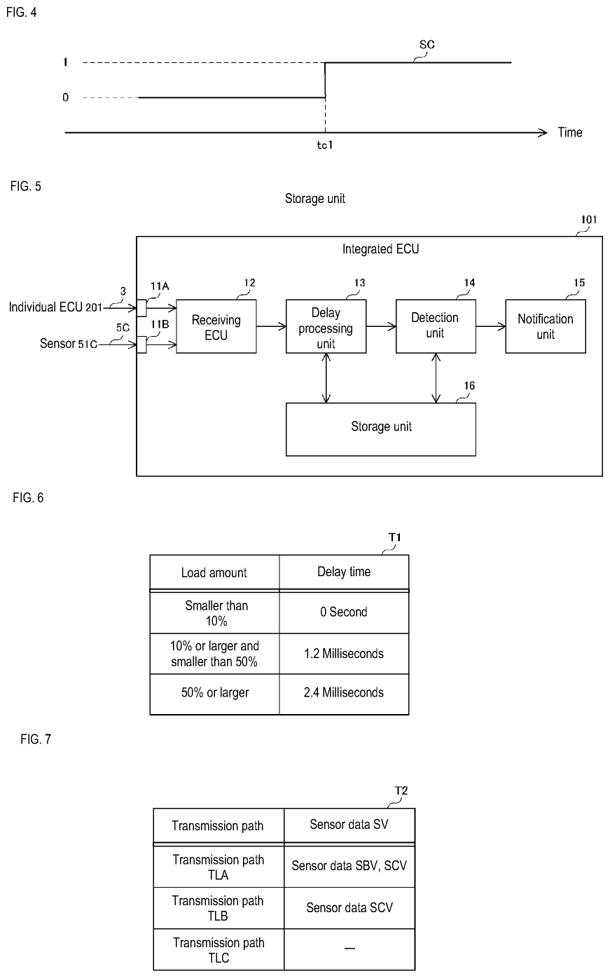

FIG. 4 is a diagram showing an example of sensor data that is transmitted by a sensor in the on-board communication system according to the embodiment of the present disclosure. FIG. 4 shows a timing chart of the sensor data SC that is transmitted by the sensor 51C. In FIG. 4, the horizontal axis indicates time.

As shown in FIG. 4, when the doors of the vehicle 1 are closed, the sensor 51C stores the sensor data SC whose value is “0”, in a frame, and transmits the frame to the integrated ECU 101, and, when a door of the vehicle 1 is open, the sensor 51C stores the sensor data SC whose value is “1”, in a frame, and transmits the frame to the integrated ECU 101.

The value of the sensor data SC changes from “0” to “1” when a door of the vehicle 1 is opened at time tc1, for example. The sensor data SC at a timing when the value changed from “0” to “1”, out of the sensor data SC that is periodically transmitted by the sensor 51C, is also referred to as “the sensor data SCV”.

Note that the sensors 51A and 51B may also be configured to transmit an analog signal indicating a measurement result to the individual ECU 201. In addition, the sensor 51C may also be configured to transmit an analog signal indicating a measurement result to the integrated ECU 101.

The individual ECU 201 relays the frames received from the sensors 51A and 51B, to the integrated ECU 101. Note that the individual ECU 201 may be configured to obtain the sensor data SA from a frame received from the sensor 51A, process the obtained sensor data SA, store the processed sensor data SA in a frame, and transmit the frame to the integrated ECU 101. In addition, the individual ECU 201 may also be configured to obtain the sensor data SB from a frame received from the sensor 51B, process the obtained sensor data SB, store the processed sensor data SB in a frame, and transmit the frame to the integrated ECU 101.

The integrated ECU 101 generates control information for controlling an actuator (not illustrated) connected to the individual ECU 201, for example, and transmits a frame that stores the generated control information to the individual ECU 201. The individual ECU 201 receives the control information from the integrated ECU 101, and drives the actuator based on the received control information. In this manner, the on-board communication system 301 has a network configuration in which the integrated ECU 101 controls driving of the actuator driven by the individual ECU 201. With such a network configuration, a new function can be added to the on-board communication system 301 using a simple method for updating firmware of the integrated ECU 101, or the like, and thus it is possible to flexibly respond to a need to add a function to the on-board communication system 301.

### Integrated ECU

FIG. 5 is a diagram showing a configuration of the integrated ECU according to the embodiment of the present disclosure. As shown in FIG. 5, the integrated ECU 101 includes communication ports 11A and 11B, a receiving unit 12, a delay processing unit 13, a detection unit 14, a notification unit 15, and a storage unit 16.

The receiving unit 12, the delay processing unit 13, the detection unit 14, and the notification unit 15 are each realized by a processor such as a CPU (Central Processing Unit) or a DSP (Digital Signal Processor). The storage unit 16 is a non-volatile memory, for example. Note that at least one of the notification unit 15 and the storage unit 16 may be provided outside the integrated ECU 101.

The communication ports 11A and 11B are terminals to which a cable can be connected. The individual ECU 201 is connected to the communication port 11A via the cable 3. The sensor 51C is connected to the communication port 11B via the cable 5C.

### Receiving of Sensor Data

The receiving unit 12 receives, via the cables 3 and 5, a plurality of pieces of change information respectively indicating changes in measurement results of the plurality of sensors 51.

More specifically, the receiving unit 12 receives a frame periodically transmitted from the sensor 51A, via the cable 5A, the individual ECU 201, the cable 3, and the communication port 11A, and obtains the sensor data SA from the received frame. The receiving unit 12 confirms the value of the obtained sensor data SA, and determines whether or not the obtained sensor data SA is the sensor data SAV. Specifically, the receiving unit 12 detects, as the sensor data SAV, the sensor data SA whose value is “1” and for which the value of the sensor data SA obtained from the previously received frame is “0”, out of the obtained sensor data SA. The receiving unit 12 outputs the detected sensor data SAV to the delay processing unit 13.

In addition, the receiving unit 12 receives a frame periodically transmitted from the sensor 51B, via the cable 5B, the individual ECU 201, the cable 3, and the communication port 11A, and obtains the sensor data SB from the received frame. The receiving unit 12 confirms the value of the obtained sensor data SB, and determines whether or not the obtained sensor data SB is the sensor data SBV. Specifically, the receiving unit 12 detects, as the sensor data SBV, the sensor data SB whose value is “1”, and for which the value of the sensor data SB obtained from the previously received frame is “0”, out of the obtained sensor data SB. The receiving unit 12 outputs the detected sensor data SBV to the delay processing unit 13.

In addition, the receiving unit 12 receives a frame periodically transmitted from the sensor 51C, via the cable 5C and the communication port 11B, and obtains the sensor data SC from the received frame. The receiving unit 12 confirms the value of the obtained sensor data SC, and determines whether or not the obtained sensor data SC is the sensor data SCV. Specifically, the receiving unit 12 detects, as the sensor data SCV, the sensor data SC whose value is “1”, and for which the value of the sensor data SC obtained from the previously received frame is “0”, out of the obtained sensor data SC. The receiving unit 12 outputs the detected sensor data SCV to the delay processing unit 13.

The sensor data SAV, sensor data SBV, and sensor data SCV are examples of change information. Hereinafter, each of the sensor data SAV, sensor data SBV, and sensor data SCV is also referred to as “sensor data SV”.

When the sensor data SAV is detected, for example, the receiving unit 12 measures the load amount of a transmission path TLA consisting of the cable 5A and the cable 3. As an example, the receiving unit 12 is monitoring a receiving frequency fa of frames that store the sensor data SA. When the sensor data SAV is detected, the receiving unit 12 calculates the load amount of the transmission path TLA that is expressed in percentage based on a predetermined calculating formula and the receiving frequency fa, and outputs load information La indicating the calculated load amount to the delay processing unit 13.

In addition, for example, when the sensor data SBV is detected, the receiving unit 12 measures the load amount of a transmission path TLB consisting of the cable 5B and the cable 3. As an example, the receiving unit 12 is monitoring a receiving frequency fb of frames that store the sensor data SB. When the sensor data SBV is detected, the receiving unit 12 calculates the load amount of the transmission path TLB that is expressed in percentage based on a predetermined calculating formula and the receiving frequency fb, and outputs load information Lb indicating the calculated load amount to the delay processing unit 13.

In addition, when the sensor data SCV is detected, for example, the receiving unit 12 measures the load amount of a transmission path TLC consisting of the cable 5C. As an example, the receiving unit 12 is monitoring a receiving frequency fc of frames that store the sensor data SC. When the sensor data SCV is detected, the receiving unit 12 calculates the load amount of the transmission path TLC that is expressed in percentage based on a predetermined calculating formula and the receiving frequency fc, and outputs load information Lc indicating the calculated load amount to the delay processing unit 13.

### Delay Processing

The delay processing unit 13 performs delay processing for delaying and outputting at least one piece of the sensor data SV received by the receiving unit 12.

FIG. 6 is a diagram showing an example of a delay time table stored in the storage unit of the integrated ECU according to the embodiment of the present disclosure. As shown in FIG. 6, the storage unit 16 stores a delay time table T1 indicating a correspondence relation between load amount of a transmission path and delay time to be used in delay processing. The delay time table T1 indicates that a delay time to be used in delay processing is zero second if the load amount of the transmission path is smaller than 10%, a delay time to be used in delay processing is 1.2 milliseconds if the load amount of the transmission path is larger than or equal to 10% and smaller than 50%, and a delay time to be used in delay processing is 2.4 milliseconds if the load amount of the transmission path is larger than or equal to 50%.

FIG. 7 is a diagram showing an example of a correspondence table stored in the storage unit of the integrated ECU according to the embodiment of the present disclosure. As shown in FIG. 7, the storage unit 16 stores a correspondence table T2 indicating a correspondence relation between sensor data SV to be delayed and transmission path that satisfies a predetermined condition that the load amount is higher than or equal to 10%, for example. The correspondence table T2 indicates that the sensor data SBV and the sensor data SCV are to be delayed if the load amount of the transmission path TLA is 10% or higher, and the sensor data SCV is to be delayed if the load amount of the transmission path TLB is 10% or higher. The correspondence table T2 is an example of correspondence information.

The delay processing unit 13 adjusts a delay time in delay processing based on a load amount of a transmission path, for example. In addition, for example, the delay processing unit 13 delays the sensor data SV received by the receiving unit 12 via another transmission path by a time that is based on the load amount of the transmission path. More specifically, the delay processing unit 13 performs delay processing based on the delay time table T1 and the correspondence table T2 in the storage unit 16. That is to say, the delay processing unit 13 selectively delays the sensor data SV based on the delay time table T1 and the correspondence table T2.

The delay processing unit 13 adjusts a delay time in delay processing based on measurement results of the load amounts of the transmission paths TLA, TLB, and TLC, for example. More specifically, the delay processing unit 13 receives the sensor data SAV, SBV, and SCV and the load information La, Lb, and Lc, and dynamically sets delay times of the sensor data SAV, SBV, and SCV based on the load amounts respectively indicated by the load information La, Lb, and Lc, the delay time table T1, and the correspondence table T2.

As an example, if the load amount of the transmission path TLA indicated by the load information La is 5%, the load amount of the transmission path TLB indicated by the load information Lb is 60%, and the load amount of the transmission path TLC indicated by the load information Lc is 3%, then the delay processing unit 13 sets the delay times of the sensor data SAV and SBV to zero based on the delay time table T1 and the correspondence table T2 in the storage unit 16, while setting the delay time of the sensor data SCV to 2.4 milliseconds.

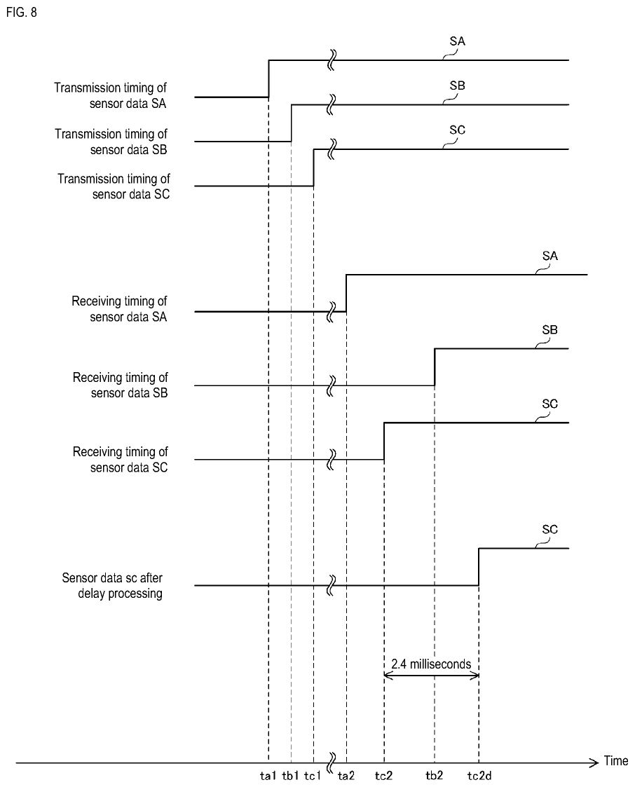

FIG. 8 is a diagram showing an example of delay processing that is performed by the delay processing unit of the integrated ECU according to the embodiment of the present disclosure. FIG. 8 shows a timing chart of the sensor data SAV, SBV, and SCV. In FIG. 8, the horizontal axis indicates the time.

Assume that, as shown in FIG. 8, the sensor data SA transmitted by the sensor 51A changes from “0” to “1” at time ta1, the sensor data SB transmitted by the sensor 51B changes from “0” to “1” at time tb1 that is later than time ta1, and the sensor data SC transmitted by the sensor 51C changes from “0” to “1” at time tc1 that is later than time tb1. That is to say, the sensor 51A transmits the sensor data SAV to the individual ECU 201 at time ta1, the sensor 51B transmits the sensor data SBV to the individual ECU 201 at time tb1, and the sensor 51C transmits the sensor data SCV to the integrated ECU 101 at time tc1. Therefore, an external transmission sequence in which the sensors 51 transmit the sensor data SV is the order of the sensor data SAV, then the sensor data SBV, and then the sensor data SCV.

The receiving unit 12 of the integrated ECU 101 then detects the sensor data SAV at time ta2, outputs the sensor data SAV to the delay processing unit 13, detects the sensor data SCV at time tc2 that is later than time ta2, outputs the sensor data SCV to the delay processing unit 13, detects the sensor data SBV at time tb2 that is later than time tc2, and outputs the sensor data SBV to the delay processing unit 13. Therefore, a receiving sequence in which the receiving unit 12 receives the sensor data SV is the order of the sensor data SAV, then the sensor data SCV, and then the sensor data SBV.

That is to say, although a transmission timing when the sensor 51B transmits the sensor data SBV is earlier than a transmission timing when the sensor 51C transmits the sensor data SCV, a receiving timing when the receiving unit 12 receives the sensor data SBV is later than a receiving timing of the sensor data SCV due to the influence from a transmission delay of the sensor data SB that is based on the traffic on the transmission path TLB, the processing load on the individual ECU 201, and the like.

The delay processing unit 13 delays the sensor data SCV such that an internal output sequence that is an output sequence in which the sensor data SV is output from the delay processing unit 13 differs from a receiving sequence in which the receiving unit 12 receives the sensor data SV.

More specifically, for example, the delay processing unit 13 receives the sensor data SAV from the receiving unit 12 at time ta2, and outputs the received sensor data SAV to the detection unit 14 at time ta2 without performing delay processing on the sensor data SAV.

In addition, the delay processing unit 13 receives the sensor data SCV from the receiving unit 12, for example, at time tc2 that is later than time ta2, and holds the received sensor data SCV for 2.4 seconds, and outputs the sensor data SCV to the detection unit 14 at time tc2d that is 2.4 second later than time tc2.

In addition, the delay processing unit 13 receives the sensor data SBV from the receiving unit 12, for example, at time tb2 that is later than time tc2, and outputs the received sensor data SBV to the detection unit 14 at time tb2 that is earlier than time tc2d, without performing delay processing on the sensor data SBV.

That is to say, the delay processing unit 13 receives the sensor data SV from the receiving unit 12 in order of the sensor data SAV, the sensor data SCV, and the sensor data SBV, and outputs the sensor data SAV, the sensor data SBV, and the sensor data SCV to the detection unit 14 in the stated order.

### Detection Processing

The detection unit 14 detects an abnormality based on the internal output sequence that is an output sequence in which the delay processing unit 13 outputs the sensor data SV. More specifically, the detection unit 14 detects an abnormality based on an input sequence that is the order in which the sensor data SV is received from the delay processing unit 13.

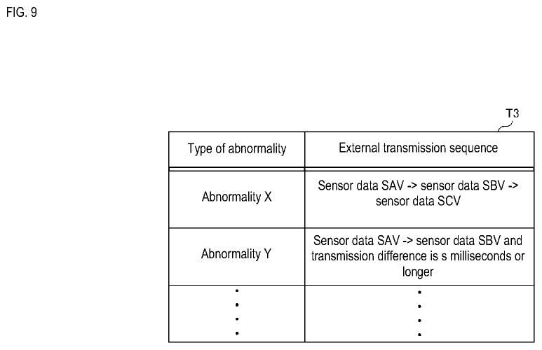

FIG. 9 is a diagram showing an example of an abnormality type table stored in the storage unit of the integrated ECU according to the embodiment of the present disclosure. As shown in FIG. 9, the storage unit 16 stores an abnormality type table T3 indicating a correspondence relation between type of abnormality that is detected by the detection unit 14 and external transmission sequence in which the sensor 51 transmits the sensor data SV. The abnormality type table T3 is an example of abnormality type information.

The abnormality type table T3 indicates a correspondence relation between an abnormality and criterion for determination of the occurrence of the abnormality, that is to say, an external transmission sequence in which the sensor 51 transmits the sensor data SV, for example.

Specifically, if a condition is satisfied that the external transmission sequence in which the sensor 51 transmits the sensor data SV is the order of the sensor data SAV, then the sensor data SBV, and then the sensor data SCV, the abnormality type table T3 indicates that an abnormality X has not occurred. The abnormality X is, for example, the vehicle 1 being abnormally entered, that is to say, a person other than an authorized user forcefully opening a door of the vehicle 1 and entering the vehicle 1.

In addition, if a condition is satisfied that the external transmission sequence in which the sensor 51 transmits the sensor data SV is the order of the sensor data SAV and then the sensor data SBV, and the difference in transmission time between the sensor data SAV and the sensor data SBV is S milliseconds or longer, the abnormality type table T3 indicates that an abnormality Y has not occurred. The abnormality Y is shaking of the vehicle 1, for example.

The detection unit 14 detects a plurality of types of abnormalities based on the abnormality type table T3 and the internal output sequence in which the delay processing unit 13 outputs the sensor data SV.

More specifically, when an input sequence in which the sensor data SV is input from the delay processing unit 13 is the order of the sensor data SAV, then the sensor data SBV, and then the sensor data SCV, the detection unit 14 determines that the abnormality X has not occurred.

On the other hand, if the input sequence in which the sensor data SV is input from the delay processing unit 13 is an order different from the order of the sensor data SAV, then the sensor data SBV, and then the sensor data SCV, the detection unit 14 determines that the abnormality X has occurred. The detection unit 14 then outputs detection information indicating that the abnormality X has been detected, to the notification unit 15.

In addition, if the input sequence in which the sensor data SV is input from the delay processing unit 13 is the order of the sensor data SAV and then the sensor data SBV, and the difference between timings when the sensor data SAV and the sensor data SBV are received from the delay processing unit 13 is S milliseconds or longer, the detection unit 14 determines that the abnormality Y has not occurred.

On the other hand, if the input sequence in which the sensor data SV is input from the delay processing unit 13 is not the order of the sensor data SAV and then the sensor data SBV, or the difference between timings when the sensor data SAV and the sensor data SBV are received from the delay processing unit 13 is shorter than S milliseconds, the detection unit 14 determines that the abnormality Y has occurred. The detection unit 14 then outputs, to the notification unit 15, detection information indicating that the abnormality Y has been detected.

When the detection information is received from the detection unit 14, the notification unit 15 issues an alert.

As shown in FIG. 8 again, in a configuration in which the detection unit 14 detects an abnormality based on the receiving sequence in which the receiving unit 12 receives the sensor data SV, although the external transmission sequence in which the sensor 51 transmits the sensor data SV is the order of the sensor data SAV, then the sensor data SBV, and then the sensor data SCV, the receiving sequence in which the receiving unit 12 receives the sensor data SV is the order of the sensor data SAV, then the sensor data SCV, and then the sensor data SBV, and thus the abnormality X is falsely detected, and error notification is performed by the notification unit 15.

In contrast, due to a configuration in which the detection unit 14 performs abnormality detection based on the internal output sequence in which the delay processing unit 13 outputs the sensor data SV, it is possible to suppress false detection of an abnormality caused by inversion of the receiving sequence in which the receiving unit 12 receives the sensor data SBV and the sensor data SCV due to the influence from a transmission delay of the sensor data SB.

### Operation Flow

Each apparatus in the on-board communication system according to an embodiment of the present disclosure includes a computer that includes a memory, and a computation processing unit in the computer such as a CPU reads out, from the memory, a program that includes some or all of the steps of the following flowchart and sequence, and executes the program. The programs of the plurality of apparatuses can be installed from outside. The programs of the apparatuses are distributed in a state of being stored in a recording medium, or through a communication line.

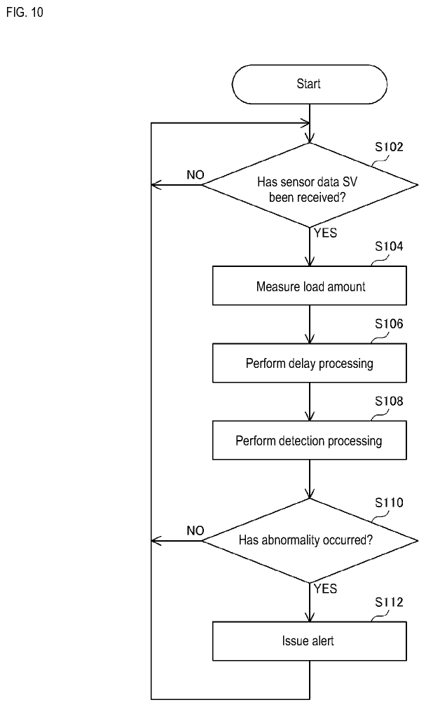

FIG. 10 is a flowchart that defines an example of an operation procedure when the integrated ECU according to the embodiment of the present disclosure performs abnormality detection.

As shown in FIG. 10, first, the integrated ECU 101 waits for the sensor data SV from the sensor 51. More specifically, the receiving unit 12 of the integrated ECU 101 obtains sensor data from frames received from the sensors 51 directly or via the individual ECU 201, and determines whether or not the obtained sensor data is the sensor data SV (NO in step S102).

Next, when the sensor data SV is received from the sensors 51, that is to say, when the sensor data SV is detected (YES in step S102), the receiving unit 12 of the integrated ECU 101 measures the load amounts of the transmission paths TLA, TLB, and TLC (step S104).

Next, the integrated ECU 101 sets delay times for the sensor data SAV, SBV, and SCV based on the load amounts of the transmission paths TLA, TLB, and TLC, the delay time table T1, and the correspondence table T2, and performs delay processing. More specifically, the delay processing unit 13 of the integrated ECU 101 receives the sensor data SAV, SAB, and SAC from the receiving unit 12, and delays and outputs at least one of the received sensor data SAV, SAB, and SAC (step S106).

Next, the detection unit 14 of the integrated ECU 101 performs detection processing based on the internal output sequence in which the delay processing unit 13 outputs the sensor data SAV, SAB, and SAC. More specifically, the detection unit 14 determines whether or not an abnormality has occurred, based on the abnormality type table T3 in the storage unit 16 and the internal output sequence in which the delay processing unit 13 outputs the sensor data SAV, SAB, and SAC (step S108).

Next, if it is determined that an abnormality has not occurred (NO in step S110), the integrated ECU 101 waits for new sensor data SV from the sensors 51 (NO in step S102).

On the other hand, if it is determined that an abnormality has occurred (YES in step S110), the integrated ECU 101 issues an alert (step S112).

Next, the integrated ECU 101 waits for new sensor data SV from the sensor 51 (NO in step S102).

Note that the on-board communication system 301 according to the embodiment of the present disclosure has a configuration in which the sensors 51 periodically perform a measurement during a period during which the vehicle 1 is parked, but there is no limitation thereto. A configuration may also be adopted in which the sensors 51 periodically perform a measurement during a period during which the vehicle 1 is travelling, in place of the period during which the vehicle 1 is parked or in addition to the period during which the vehicle 1 is parked.

In addition, the on-board communication system 301 according to the embodiment of the present disclosure has a configuration in which the sensor 51A periodically generates the sensor data SA and transmits the generated sensor data SA to the individual ECU 201, but there is no limitation thereto. A configuration may also be adopted in which the sensor 51A periodically performs a measurement, and transmits, to the individual ECU 201, only the sensor data SA at a timing when the value changes from “0” to “1” due to a person touching the vehicle body of the vehicle 1. That is to say, a configuration may also be adopted in which the sensor 51A transmits the sensor data SAV out of the sensor data SA to the individual ECU 201, but does not transmit the sensor data SA other than the sensor data SAV.

Similarly, a configuration may be adopted in which the sensor 51B transmits the sensor data SBV out of the sensor data SB to the individual ECU 201, while not transmitting the sensor data SB other than the sensor data SBV. In addition, a configuration may also be adopted in which the sensor 51C transmits the sensor data SCV out of the sensor data SC to the integrated ECU 101, while not transmitting the sensor data SC other than the sensor data SCV.

In addition, the integrated ECU 101 according to the embodiment of the present disclosure has a configuration in which the delay processing unit 13 adjusts a delay time in delay processing based on the load amounts of the transmission paths, but there is no limitation thereto. A configuration may also be adopted in which the delay processing unit 13 adjusts a delay time, for example, based on the processing load of the individual ECU 201 that is different from the load amounts of the transmission paths.

In addition, the integrated ECU 101 according to the embodiment of the present disclosure has a configuration in which the delay processing unit 13 delays the sensor data SCV such that the internal output sequence of the sensor data SV differs from the receiving sequence in which the receiving unit 12 receives the sensor data SV, but there is no limitation thereto. A configuration may also be adopted in which the delay processing unit 13 delays and outputs the sensor data SCV such that the internal output sequence of the sensor data SV is the same as the receiving sequence in which the receiving unit 12 receives the sensor data SV, and the output interval of the sensor data SV differs from the receiving interval at which the receiving unit 12 receives the sensor data SV.

In addition, the integrated ECU 101 according to the embodiment of the present disclosure has a configuration in which the delay processing unit 13 delays the sensor data SV received by the receiving unit 12 via a transmission path by a time that is based on a load amount of another transmission path, but there is no limitation thereto. A configuration may also be adopted in which the delay processing unit 13 does not delay the sensor data SV received by the receiving unit 12 via a transmission path by a time that is based on a load amount of another transmission path, while delaying the sensor data SV received by the receiving unit 12 via a common transmission path.

In addition, the integrated ECU 101 according to the embodiment of the present disclosure has a configuration in which the delay processing unit 13 adjusts a delay time in delay processing based on the measurement results of the load amounts of the transmission paths TLA, TLB, and TLC, but there is no limitation thereto. A configuration may also be adopted in which the delay processing unit 13 adjusts a delay time in delay processing based on a measurement result of a load amount of a partial transmission path of the transmission paths TLA, TLB, and TLC.

Incidentally, in conventional abnormality detection techniques, there are cases where false detection occurs in abnormality detection that is based on a measurement result of a sensor, depending on a situation of an on-board network. Specifically, in a configuration in which abnormality detection is performed based on a receiving sequence of the sensor data SV, for example, a receiving sequence of the sensor data SV differs from an external transmission sequence in which the sensor 51 transmits the sensor data SV, due to the influence from a transmission delay of the sensor data SV in an on-board network, and false detection occurs.

In contrast, the receiving unit 12 of the integrated ECU 101 according to the embodiment of the present disclosure receives, via the transmission paths, a plurality of pieces of sensor data SV respectively indicating changes in measurement results of the plurality of sensors 51 mounted in the vehicle 1. The delay processing unit 13 performs delay processing for delaying and outputting at least one of the plurality of pieces of sensor data SV received by the receiving unit 12. The detection unit 14 detects an abnormality based on the internal output sequence that is the output sequence in which the delay processing unit 13 outputs the plurality of pieces of sensor data SV.

Due to a configuration in which delay processing for delaying and outputting at least one of the pieces of received sensor data SV is performed, and abnormality detection is performed based on the internal output sequence of the plurality of pieces of sensor data SV in this manner, for example, it is possible to determine whether or not an abnormality has occurred, based on an internal output sequence for which the influence from a transmission delay of the sensor data SV is reduced and whose content is closer to the external transmission sequence in which the sensors transmit the sensor data SV, and thus it is possible to suppress false detection caused by the influence from a transmission delay of the sensor data SV.

Therefore, with the integrated ECU 101 according to the embodiment of the present disclosure, it is possible to suppress the occurrence of false detection in abnormality detection that is based on measurement results of the sensors 51.

The above embodiments are examples in all respects and should not be interpreted as limiting in any manner. The scope of the present disclosure is defined not by the foregoing descriptions, but by the claims and intended to include all modifications within the meaning and scope equivalent to the claims.

The foregoing description includes characteristics to be added as below.

An on-board apparatus to be mounted in a vehicle, including: a receiving unit configured to receive, via a transmission path, a plurality of pieces of change information respectively indicating changes in measurement results of a plurality of sensors mounted in the vehicle, a delay processing unit configured to perform delay processing for delaying and outputting at least one of the plurality of pieces of change information received by the receiving unit, and a detection unit configured to detect an abnormality based on an internal output sequence that is an output sequence in which the delay processing unit outputs the plurality of pieces of change information, and the delay processing unit dynamically adjusts a delay time in the delay processing based on a measurement result of a load amount of the transmission path.

1. An on-board apparatus to be mounted in a vehicle, comprising:
a receiving unit configured to receive, via a transmission path, a plurality of pieces of change information respectively indicating changes in measurement results of a plurality of sensors mounted in the vehicle;
a delay processing unit configured to perform delay processing for delaying and outputting at least one of the plurality of pieces of change information received by the receiving unit; and
a detection unit configured to detect an abnormality based on an internal output sequence that is an output sequence in which the delay processing unit outputs the plurality of pieces of change information.

2. The on-board apparatus according to claim 1,
wherein the delay processing unit adjusts a delay time in the delay processing based on a load amount of the transmission path.

3. The on-board apparatus according to claim 1,
wherein the delay processing unit delays the change information such that the internal output sequence differs from a receiving sequence in which the receiving unit receives the plurality of pieces of change information.

4. The on-board apparatus according to claim 1,
wherein the delay processing unit delays the change information received by the receiving unit via another transmission path, by a time that is based on a load amount of the transmission path.

5. The on-board apparatus according to claim 1,
wherein the delay processing unit adjusts a delay time in the delay processing based on measurement results of load amounts of a plurality of transmission paths.

6. The on-board apparatus according to claim 1, further comprising:
a storage unit configured to store correspondence information indicating a correspondence relation between a transmission path for which a load amount satisfies a predetermined condition and change information to be delayed,
wherein the delay processing unit performs the delay processing based on the correspondence information.

7. The on-board apparatus according to claim 1, further comprising:
a storage unit configured to store abnormality type information indicating a correspondence relation between a type of abnormality to be detected by the detection unit, and an external transmission sequence in which the plurality of sensors transmit the plurality of pieces of change information,
wherein the detection unit detects a plurality of types of abnormalities based on the abnormality type information and the internal output sequence.

8. An abnormality detection method for an on-board apparatus that is to be mounted in a vehicle, comprising:
a step of receiving, via a transmission path, a plurality of pieces of change information respectively indicating changes in measurement results of a plurality of sensors mounted in the vehicle;
a step of performing delay processing for delaying and outputting at least one of the plurality of pieces of received change information; and
a step of detecting an abnormality based on an internal output sequence that is an output sequence of the plurality of pieces of change information.

9. An abnormality detection program in an on-board apparatus to be mounted in a vehicle, the program being for causing a computer to function as:
a receiving unit configured to receive, via a transmission path, a plurality of pieces of change information respectively indicating changes in measurement results of a plurality of sensors mounted in the vehicle;
a delay processing unit configured to perform delay processing for delaying and outputting at least one of the plurality of pieces of change information received by the receiving unit; and
a detection unit configured to detect an abnormality based on an internal output sequence that is an output sequence in which the delay processing unit outputs the plurality of pieces of change information.
